(19) United States
(12) Patent Application Publication
(10) Pub. No.: US 2024/0300128 A1
(43) Pub. Date: Sep. 12, 2024

(54) GEAR SLICING TOOL AND MANUFACTURE METHOD THEREOF

(71) Applicant: JIANGSU XCMG CONSTRUCTION MACHINERY RESEARCH INSTITUTE LTD., Xuzhou (CN)

(72) Inventors: Xinchun CHEN, Xuzhou (CN); Mengxue BI, Xuzhou (CN); Sen FENG, Xuzhou (CN)

(21) Appl. No.: 18/321,927

(22) Filed: May 23, 2023

(30) Foreign Application Priority Data
Mar. 7, 2023 (CN) 202310220212.X

(51) Int. Cl. B26D 1/00; B26D 1/143

(52) U.S. Cl. CPC B26D 1/0006; B26D 1/143; B26D 2001/002; B26D 2001/0053; B26D 2001/006

(57) ABSTRACT

A gear slicing tool and a manufacture method thereof are provided. The gear slicing tool includes a gear slicing tool body having concave and/or convex parts formed on a tool surface of the gear slicing tool body and a composite film layer disposed on the tool surface. The composite film layer includes a metal film layer, a transition film layer, and a functional film layer. A material of the metal film layer includes a metal. The transition film layer includes a first film layer and a second film layer. A material of the first film layer includes a nitride of the metal. A material of the second film layer includes a nitride of an alloy of the metal and aluminum. A material of the functional film layer includes a nitride of an alloy of the metal, aluminum, and silicon.

### CROSS-REFERENCE TO RELATED APPLICATIONS

The present application claims priority to China Patent Application No. 202310220212.X filed on Mar. 7, 2023, the disclosure of which is incorporated by reference herein in its entirety.

### TECHNICAL FIELD

The present disclosure relates to the technical field of cutting tool, in particular to a gear slicing tool and a manufacture method thereof.

### BACKGROUND

The design structural form and manufacturing accuracy of gears, as basic components, directly affect the performances of transmission elements and construction machinery transmission systems. At present, conventional gear manufacturing technologies, such as gear hobbing and gear shaping, cannot meet the processing of lightweight gear parts, such as internal teeth without relief grooves and duplicate gears, and the innovative research and development of the transmission elements. The gear ring is easy to deform in the gear shaping processing of a thin-walled gear ring and has poor accuracy (8-9 grades) and low processing efficiency (40-50 min/piece), which cannot meet the high-accuracy and efficient production of high-end transmission elements, and seriously limits the high-end development of construction machinery.

A gear slicing technology is a new gear processing technology gradually developed in the 21st century, can not only realize the processing of the lightweight gear parts, such as internal teeth without relief grooves and duplicate gears, but also realize dry cutting. The processing accuracy reaches GB/T 6 grade and above, the processing efficiency is 3-4 times higher than that of gear hobbing and gear shaping, and remarkable characteristics such as high accuracy, high efficiency and environmental protection are achieved.

### SUMMARY

Through research, inventors found that there is a bottleneck problem in an industrialization process of the gear slicing technology, that is, the gear slicing tool wears quickly and has a short service life, which limits batch application of the gear slicing technology.

In view of this, embodiments of the present disclosure provide a gear slicing tool and a manufacture method thereof, which can improve the service life of the cutting tool.

In one aspect of the present disclosure, a gear slicing tool is provided and includes: a gear slicing tool body, wherein a plurality of concave and/or convex parts are formed on a tool surface of the gear slicing tool body, and the plurality of concave and/or convex parts are arranged at intervals along at least one direction on the tool surface; and a composite film layer disposed on the tool surface, wherein the composite film layer includes: a metal film layer formed on the tool surface and covering a surface of the plurality of concave and/or convex parts, wherein a material of the metal film layer includes metal; a transition film layer disposed on one side of the metal film layer away from the tool surface, wherein the transition film layer includes a first film layer formed on the metal film layer and a second film layer formed on the first film layer, a material of the first film layer includes a nitride of the metal, and a material of the second film layer includes a nitride of an alloy of the metal and aluminum; and a functional film layer disposed on one side of the transition film layer away from the tool surface, and a material of the functional film layer includes a nitride of an alloy of the metal, aluminum and silicon.

In some embodiments, the metal is chromium or titanium.

In some embodiments, a thickness of the metal film layer is 0.2-0.3 μm, and/or a thickness of the transition film layer is 0.5-0.8 μm, and/or a thickness of the functional film layer is 1-3 μm.

In some embodiments, the tool surface includes a front tool surface, the plurality of concave and/or convex parts include a plurality of circular concave portions, a plurality of transverse grooves, a plurality of fan-shaped grooves or a plurality of crescent-shaped concave portions, and the plurality of circular concave portions, the plurality of transverse grooves, the plurality of fan-shaped grooves or the plurality of crescent-shaped concave portions are formed on the front tool surface.

In some embodiments, the tool surface includes a front tool surface and a rear tool surface, the plurality of concave and/or convex parts include a plurality of circular concave portions and a plurality of transverse grooves, and the plurality of circular concave portions and the plurality of transverse grooves are formed on the front tool surface and the rear tool surface.

In some embodiments, respective transverse grooves extend along a first direction, the plurality of transverse grooves are arranged at intervals along a second direction perpendicular to the first direction, the plurality of circular concave portions include a plurality of rows of circular concave portions arranged at intervals along the second direction, and each row of circular concave portions are at least partially located in the corresponding transverse grooves.

In some embodiments, the tool surface includes a front tool surface and a rear tool surface, the plurality of concave and/or convex parts include a plurality of circular concave portions and a plurality of crescent-shaped concave portions, and the plurality of circular concave portions and the plurality of crescent-shaped concave portions are formed on the front tool surface and the rear tool surface.

In some embodiments, the plurality of circular concave portions and the plurality of crescent-shaped concave portions are arranged in an array, and the plurality of circular concave portions and the plurality of crescent-shaped concave portions are alternately disposed along at least one arrangement direction of the array.

In some embodiments, the tool surface includes a front tool surface and a rear tool surface, the plurality of concave and/or convex parts include a plurality of circular convex portions, and the plurality of circular convex portions are formed on the front tool surface and the rear tool surface.

In some embodiments, the plurality of concave and/or convex parts further include a plurality of circular concave portions, a plurality of fan-shaped grooves or a plurality of crescent-shaped concave portions, and the plurality of circular concave portions, the plurality of fan-shaped grooves or the plurality of crescent-shaped concave portions are formed on the front tool surface and the rear tool surface.

In some embodiments, the plurality of circular convex portions are arranged in an array, and the plurality of circular concave portions, the plurality of fan-shaped grooves or the plurality of crescent-shaped concave portions are arranged in an array and are alternately disposed with the plurality of circular convex portions along at least one direction of the array.

In some embodiments, the circular concave portion has a diameter of 30-50 μm and a depth of 10-150 μm, and a distance between adjacent circular concave portions is 40-100 μm.

In some embodiments, the circular convex portion has a diameter of 30-50 μm and a height of 10-150 μm, and a distance between adjacent circular convex portions is 40-100 μm.

In some embodiments, the transverse groove has a width of 40-100 μm and a depth of 10-150 μm, and a distance between adjacent transverse grooves is 40-100 μm.

In some embodiments, the fan-shaped groove has a diameter of 30-50 μm, a fan-shaped included angle of 40°-60°, and a depth of 10-150 μm, and a distance between adjacent fan-shaped grooves is 40-100 μm.

In some embodiments, the crescent-shaped concave portion has a maximum width of 30-50 μm, a maximum length of 50-60 μm and a depth of 10-150 μm, an angle of a bottom sharp corner of the crescent-shaped concave portion is 20°-30°, and a distance between adjacent crescent-shaped concave portions is 40-100 μm.

In one aspect of the present disclosure, a manufacture method of the aforementioned gear slicing tool is provided and includes: providing a gear slicing tool body; forming a plurality of concave and/or convex parts on a tool surface of the gear slicing tool body, wherein the plurality of concave and/or convex parts are arranged at intervals along at least one direction on the tool surface; and disposing a composite film layer on the tool surface, wherein the step of disposing the composite film layer includes: forming a metal film layer on the tool surface, and covering a surface of the plurality of concave and/or convex parts with the metal film layer, wherein a material of the metal film layer includes metal; forming a first film layer on the metal film layer, wherein a material of the first film layer includes a nitride of the metal; forming a second film layer on the first film layer, wherein a material of the second film layer includes a nitride of an alloy of the metal and aluminum; and forming a functional film layer on the second film layer, wherein a material of the functional film layer includes a nitride of an alloy of the metal, aluminum and silicon.

In some embodiments, the metal film layer is formed by a pulsed arc method, and the first film layer, the second film layer and the functional film layer are all deposited by a magnetron sputtering method.

In some embodiments, the manufacture method further includes: performing ultrasonic cleaning and nitrogen gas blow-drying on the gear slicing tool body before forming the plurality of concave and/or convex parts.

In some embodiments, the manufacture method further includes: performing vacuum heating and argon gas cleaning on the gear slicing tool body before disposing the composite film layer.

Therefore, according to the embodiments of the present disclosure, the plurality of concave and/or convex parts arranged at intervals are formed on the tool surface of the gear slicing tool body, the composite film layer is disposed on the tool surface, an adhesion effect of the composite film layer on the tool surface can be enhanced by the plurality of concave and/or convex parts, and a wear resistance of the cutting tool can be improved. The composite film layer includes the metal film layer, the transition film layer including the nitride of the metal and the nitride of the alloy of the metal and aluminum, and the functional film layer including the nitride of the alloy of the metal, aluminum and silicon. The metal film layer is used as a base for attaching the transition film layer, and the transition film layer is used to buffer the influence of a sudden stress change between the functional film layer and the metal film layer, so as to improve a bonding force between the composite film layer and the gear slicing tool body. Therefore, the gear slicing tool body can reliably have better wear resistance and high temperature oxidation resistance in high-speed cutting and other scenes through the functional film layer.

### BRIEF DESCRIPTION OF THE DRAWINGS

The accompanying drawings, which form a part of the description, illustrate embodiments of the present disclosure and serve to explain the principles of the present disclosure together with the description.

The present disclosure can be more clearly understood from the following detailed descriptions with reference to the accompanying drawings, in which:

FIG. 1 is a schematic diagram of a working scene of some embodiments of a gear slicing tool according to the present disclosure;

FIG. 2 is a schematic structural diagram of some embodiments of a gear slicing tool according to the present disclosure;

FIG. 3 is an enlarged schematic diagram of circle A in FIG. 2;

FIG. 4 is a schematic diagram of a composite film layer disposed on a gear slicing tool body and covering concave and/or convex parts in an embodiment of a gear slicing tool according to the present disclosure;

FIG. 5 is a schematic structural diagram of a composite film layer in an embodiment of a gear slicing tool according to the present disclosure;

FIGS. 6-14 are schematic diagrams of a plurality of concave and/or convex parts in different forms on a tool surface in some embodiments of a gear slicing tool according to the present disclosure respectively; and

FIG. 15 is a flowchart of some embodiments of a manufacture method of a gear slicing tool according to the present disclosure.

It should be understood that the dimensions of various parts shown in the drawings are not drawn according to the actual scale relationship. In addition, the same or similar reference numerals denote the same or similar members.

### DETAILED DESCRIPTION

Various exemplary embodiments of the present disclosure will now be described in detail with reference to the accompanying drawings. The descriptions of the exemplary embodiments are merely illustrative and are in no way intended as a limitation to the present disclosure and its application or use. The present disclosure may be implemented in many different forms and is not limited to the embodiments described here. These embodiments are provided to make the present disclosure thorough and complete, and fully express the scope of the present disclosure to those skilled in the art. It should be noted: the relative arrangement, material components, numerical expressions and numerical values of the components and steps set forth in these embodiments should be construed as merely illustrative without limitations unless otherwise specified.

“First”, “second”, and similar words used in the present disclosure do not denote any order, quantity, or importance, but are merely used to distinguish different parts. “Include” or “comprise” and similar words are intended to mean that the elements before said word cover the elements listed after said word, without excluding the possibility of covering other elements. “Upper”, “lower”, “left”, “right” and the like are only used to indicate a relative positional relationship, and when the absolute position of a described object changes, the relative positional relationship may also change accordingly.

In the present disclosure, when it is described that a specific device is located between a first device and a second device, there may or may not be an intermediate device between the specific device and the first device or the second device. When it is described that the specific device is connected to other devices, the specific device may be directly connected to the other devices without the intermediate device, or may not be directly connected to the other devices with the intermediate device.

Unless otherwise particularly defined, all terms (including technical terms or scientific terms) used in the present disclosure have the same meaning as commonly understood by those ordinary skilled in the art to which the present disclosure belongs. It will be further understood that the terms, such as those defined in commonly used dictionaries, should be interpreted as having meanings consistent with their meanings in the context of the related art and will not be interpreted in an idealized or overly formal sense, unless expressly so defined herein.

Technologies, methods, and devices known to those ordinary skilled in the related art may not be discussed in detail but where appropriate, the technologies, methods, and devices should be considered as part of the description.

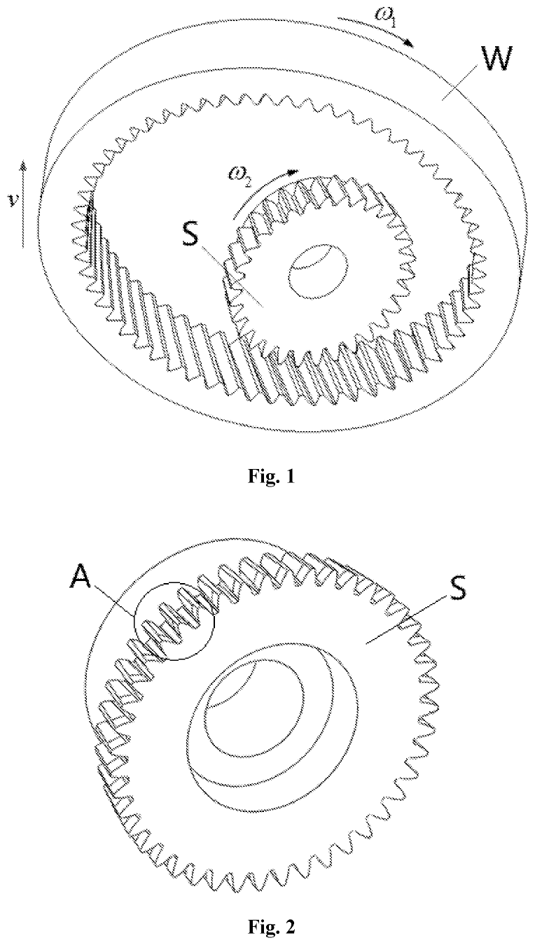

FIG. 1 is a schematic diagram of a working scene of some embodiments of a gear slicing tool according to the present disclosure. Referring to FIG. 1, the axis of a gear slicing tool S is inclined relative to the axis of a processed workpiece W, the gear slicing tool S and the workpiece W are rotated at a high speed of ω2 and ω1 respectively, and the workpiece W is also slightly fed in a direction v parallel to its own axis, thereby gradually cutting a tooth surface on the workpiece W.

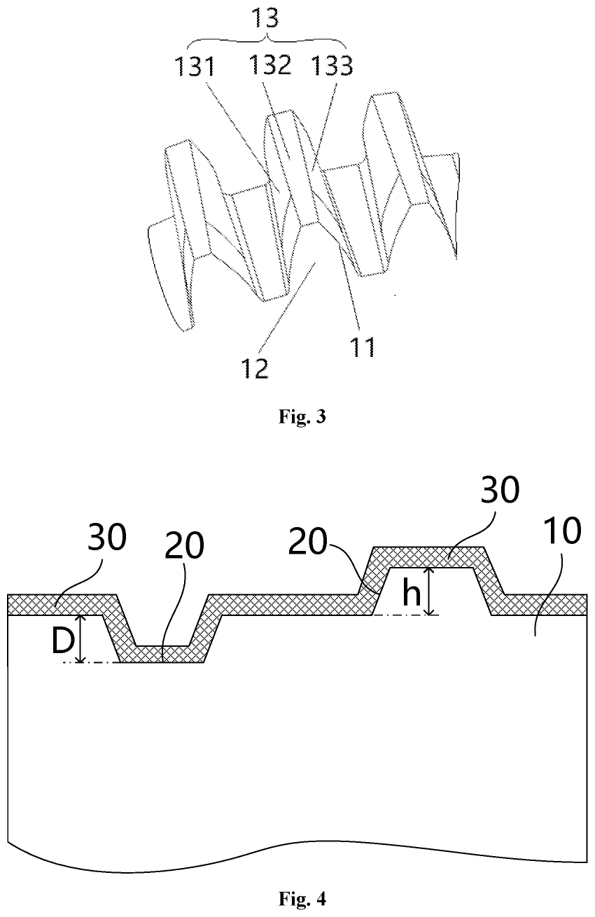

FIG. 2 is a schematic structural diagram of some embodiments of the gear slicing tool according to the present disclosure. FIG. 3 is an enlarged schematic diagram of circle A in FIG. 2. Referring to FIGS. 1 to 3, the gear slicing tool S has a plurality of cutting teeth distributed in the circumferential direction, and different parts of the cutting teeth correspond to different tool surfaces. In FIG. 3, the body of the gear slicing tool S (that is the gear slicing tool body 10) has a cutting edge 11 and a plurality of tool surfaces. The plurality of tool surfaces include a front tool surface 12 and a rear tool surface 13 divided by the cutting edge 11. During cutting, cutting chips cut by the cutting edge 11 mainly flow through the front tool surface 12, and the rear tool surface 13 may include a left rear tool surface 131, a top rear tool surface 132 and a right rear tool surface 133.

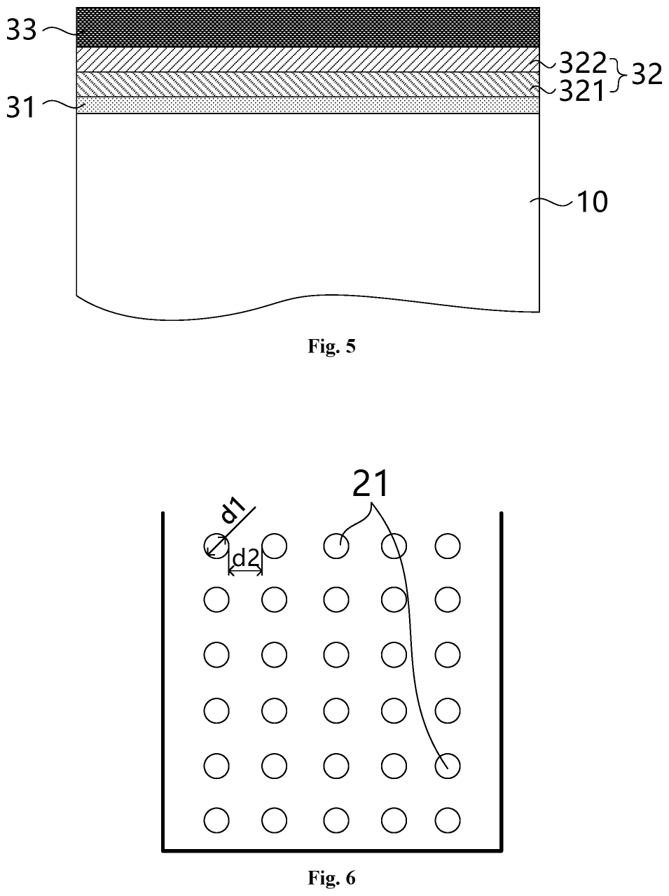

FIG. 4 is a schematic diagram of a composite film layer disposed on the gear slicing tool body and covering concave and/or convex parts in an embodiment of the gear slicing tool according to the present disclosure. FIG. 5 is a schematic structural diagram of the composite film layer in an embodiment of the gear slicing tool according to the present disclosure. Referring to FIGS. 1 to 5, the embodiment of the present disclosure provides a gear slicing tool, which includes a gear slicing tool body 10 and a composite film layer 30. A plurality of concave and/or convex parts 20 are formed on a tool surface of the gear slicing tool body 10, and the concave and/or convex parts 20 are arranged at intervals along at least one direction on the tool surface. The composite film layer 30 is disposed on the tool surface.

Here, the concave and/or convex parts 20 may include grooves or concave portions which are concave relative to the tool surface, may also include convex portions or convex ribs which are convex relative to the tool surface, and may also include the grooves or concave portions which are concave relative to the tool surface and the convex portions or convex ribs which are convex relative to the tool surface.

The composite film layer 30 includes a metal film layer 31, a transition film layer 32 and a functional film layer 33. The metal film layer 31 is formed on the tool surface and covers a surface of the plurality of concave and/or convex parts 20, and a material of the metal film layer 31 includes metal. The metal material here refers to a metallic simple substance, such as chromium (Cr) or titanium (Ti). The metal film layer 31 covers the surface of the plurality of concave and/or convex parts 20. Compared with a plat surface, the surface with a plurality of concave and/or convex parts 20 has a larger surface area, and can be more fully combined with the metal film layer 31, so as to obtain a greater bonding force, so that the composite film layer 30 is less likely to peel off from the tool surface.

The transition film layer 32 is disposed on one side of the metal film layer 31 away from the tool surface. The transition film layer 32 includes a first film layer 321 formed on the metal film layer 31 and a second film layer 322 formed on the first film layer 321. A material of the first film layer 321 includes a nitride of the metal, and a material of the second film layer 322 includes a nitride of an alloy of the metal and aluminum. The functional film layer 33 is disposed on one side of the transition film layer 32 away from the tool surface, and a material of the functional film layer 33 includes a nitride of an alloy of the metal, aluminum and silicon.

In the present embodiment, the plurality of concave and/or convex parts arranged at intervals are formed on the tool surface of the gear slicing tool body, the composite film layer is disposed on the tool surface, an adhesion effect of the composite film layer on the tool surface can be enhanced by the plurality of concave and/or convex parts, and a wear resistance of the cutting tool can be improved; the composite film layer includes the metal film layer, the transition film layer including the nitride of the metal and the nitride of the alloy of the metal and aluminum, and the functional film layer including the nitride of the alloy of the metal, aluminum and silicon. The metal film layer is used as a base for attaching the transition film layer, and the transition film layer is used to buffer the influence of a sudden stress change between the functional film layer and the metal film layer, so as to improve a bonding force between the composite film layer and the gear slicing tool body. Therefore, the gear slicing tool body can reliably have better wear resistance and high temperature oxidation resistance in high-speed cutting and other scenes through the functional film layer.

By taking the metal Cr as an example, the composite film layer is a Cr film layer, a CrN—AlCrN transition film layer and an AlCrSiN functional film layer. For the gear slicing tool body made of hard ferroalloy, the Cr film layer of the composite film layer in contact with the tool surface and the gear slicing tool body can be solidly dissolved mutually to obtain a stronger bonding force and serve as a base for attaching the transition film layer.

A hardness value of the AlCrSiN functional film can reach 3500 HV, and a highest service temperature can reach above 1000° C. Moreover, under high-speed cutting, the wear resistance and high temperature oxidation resistance are better. Considering the larger difference thermal expansion coefficients of between the functional film layer and the gear slicing tool body, the CrN—AlCrN transition film layer is disposed to improve the difference between the thermal expansion coefficients layer by layer, and buffer the influence of a sudden stress change between different materials, thereby effectively improving the bonding force between the composite film layer and the gear slicing tool body.

Considering that if the thickness of the metal film layer 31 is too large and the internal stress increases, then the metal film layer 31 is easy to peel off when in use, and the preparation efficiency is lower; and if the thickness is too small, the achieved base effect is not obvious. Therefore, in some embodiments, the thickness of the metal film layer 31 is 0.2-0.3 μm, such as 0.2 μm, 0.24 μm, 0.28 μm and 0.3 μm.

Considering that if the thickness of the transition film layer 32 is too large and the internal stress increases, then the transition film layer 32 is easy to peel off when in use, and the preparation efficiency is lower; and if the thickness is too small, the achieved transition effect is not obvious. Therefore, in some embodiments, the thickness of the transition film layer 32 is 0.5-0.8 μm, such as 0.5 μm, 0.6 μm, 0.7 μm and 0.8 μm.

Considering that if the thickness of the functional film layer 33 is too large and the internal stress increases, then the functional film layer 33 is easy to peel off when in use, and the preparation efficiency is lower; and if the thickness is too small, the achieved wear resistance, high temperature resistance and oxidation resistance are not obvious. Therefore, in some embodiments, the thickness of the functional film layer 33 is 1-3 μm, such as 1 μm, 1.6 μm, 2.4 μm and 3 μm.

For example, the nano-ceramic composite film layer with ultra-high hardness can be prepared by an unbalanced magnetron sputtering composite pulsed arc device. The coating device includes a Cr target, an AlCr alloy target and a Si target. The prepared composite film layer sequentially includes the Cr film layer, the CrN-AlCrN transition film layer and the AlCrSiN functional film layer from the tool surface of the gear slicing tool body outward, the particle ionization is greater than 90% and the roughness is less than 0.2. The thickness of the Cr film layer is 0.3 μm, the thickness of the CrN—AlCrN transition film layer is 0.6 μm, the thickness of the AlCrSiN functional film layer is 2.4 μm, and the total thickness of the composite film layer is 3.3 μm.

In some other embodiments, the composite film layer based on the metal Ti with very high hardness may also be adopted, that is, the composite film layer sequentially includes a Ti film layer, a TiN—AlTiN transition film layer and an AlTiSiN functional film layer from the tool surface of the gear slicing tool body outward.

FIG. 6-FIG. 14 are schematic diagrams of the plurality of concave and/or convex parts in different forms on the tool surface in some embodiments of the gear slicing tool according to the present disclosure respectively. Referring to FIGS. 6 to 9, in some embodiments, the tool surface includes a front tool surface 12, and the plurality of concave and/or convex parts 20 include a plurality of circular concave portions 21, a plurality of transverse grooves 22, a plurality of fan-shaped grooves 23 or a plurality of crescent-shaped concave portions 24, and the plurality of circular concave portions 21, the plurality of transverse grooves 22, the plurality of fan-shaped grooves 23 or the plurality of crescent-shaped concave portions 24 are formed on the front tool surface 12. Optionally, the plurality of circular concave portions 21, the plurality of transverse grooves 22, the plurality of fan-shaped grooves 23 or the plurality of crescent-shaped concave portions 24 may be formed in the region of the front tool surface 12 close to the cutting edge, so as to improve a film layer adhesive force in the region close to the cutting edge and reduce the processing cost and time of the concave and/or convex parts.

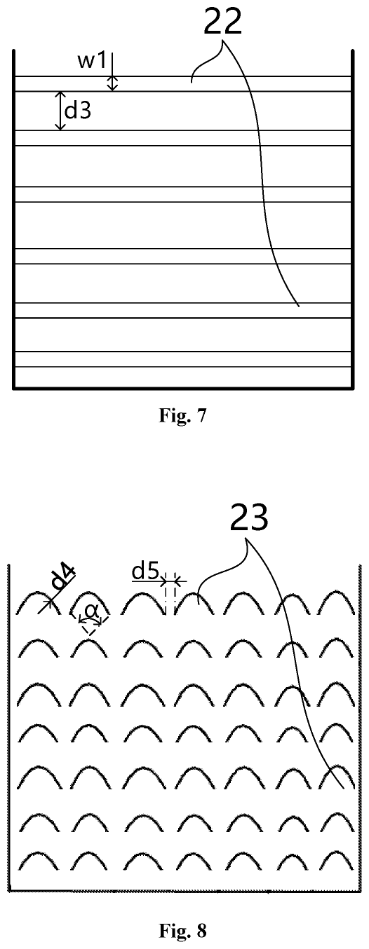

In FIGS. 6, 8 and 9, the plurality of circular concave portions 21, the plurality of fan-shaped grooves 23 or the plurality of crescent-shaped concave portions 24 are arranged at intervals in transverse and longitudinal directions to form an array. In FIG. 7, the plurality of transverse grooves 22 may be arranged at intervals in a vertical direction of the transverse grooves. These circular concave portions 21, transverse grooves 22, fan-shaped grooves 23 or crescent-shaped concave portions 24, which are disposed on the front tool surface 12, can effectively reduce friction between the cutting tool and the workpiece and guide the cutting chips to flow out quickly, and can also store a cutting fluid to generate a dynamic pressure effect of fluid, thereby further reducing the wear of the cutting tool when the gear slicing tool is used for wet cutting. In addition, these structures can reduce an interface contact area and destroy the continuity of a water film, and an airflow generates vortex in the concave portions or grooves to form an air cushion, which increases a turbulence degree of the airflow, changes the trajectory of particle movement, buffers and reduces the collision and improves the wear resistance.

Referring to FIG. 6, the values of a diameter d1 of the circular concave portions 21 and a distance d2 between adjacent circular concave portions 21 may be based on the factors of many aspects. If the diameter d1 is too large, the strength of the cutting tool body will be affected; and if the diameter d1 is too small, the processing difficulty of the circular concave portions 21 will be increased. Therefore, optionally, the diameter d1 of the circular concave portions 21 is set to be 30-50 μm, for example, 30 μm, 38 μm, 44 μm and 50 μm. If the distance d2 is too large, the effects of the circular concave portions 21 in the aspects of reducing the friction, guiding the cutting chips and the like will be reduced; and if the distance d2 is too small, the processing difficulty of the circular concave portions will be increased. Therefore, optionally, the distance d2 between adjacent circular concave portions 21 is set to be 40-100 μm, for example, 40 μm, 60 μm, 80 μm and 100 μm.

Referring to FIG. 4 and FIG. 6, the value of a depth D of the circular concave portions 21 may be based on the factors of many aspects. If the value of the depth D is too large, the strength of the cutting tool body will be affected; and if the depth D is too small, the effects of the circular concave portions 21 in the aspects of reducing the friction, guiding the cutting chips and the like will be reduced, and the processing difficulty will also be greater. Therefore, optionally, the depth D of the circular concave portions 21 is set to be 10-150 μm, for example, 10 μm, 65 μm, 110 μm and 150 μm.

Referring to FIG. 7, the values of a width w1 of the transverse grooves 22 and a distance d3 between adjacent transverse grooves 22 may be based on the factors of many aspects. If the width w1 is too large, the strength of the cutting tool body will be affected; and if the width w1 is too small, the processing difficulty of the transverse grooves 22 will be increased. Therefore, optionally, the width w1 of the transverse grooves 22 is set to be 40-100 μm, for example, 40 μm, 60 μm, 80 μm and 100 μm. If the distance d3 is too large, the effects of the transverse grooves 22 in the aspects of reducing the friction, guiding the cutting chips and the like will be reduced; and if the distance d3 is too small, the processing difficulty of the transverse grooves 22 will be increased. Therefore, optionally, the distance d3 between adjacent transverse grooves 22 is set to be 40-100 μm, for example, 40 μm, 60 μm, 80 μm and 100 μm.

Referring to FIGS. 4 and 7, the value of a depth D of the transverse grooves 22 may be based on the factors of many aspects. If the value of the depth D is too large, the strength of the cutting tool body will be affected; and if the depth D is too small, the effects of the transverse grooves 22 in the aspects of reducing the friction, guiding the cutting chips and the like will be reduced, and the processing difficulty will also be greater. Therefore, optionally, the depth D of the transverse grooves 22 is set to be 10-150 μm, for example, 10 μm, 65 μm, 110 μm and 150 μm.

Referring to FIG. 8, the values of a diameter d4 and a fan-shaped included angle α of the fan-shaped grooves 23 and a distance d5 between adjacent fan-shaped grooves 23 may be based on the factors of many aspects. If the diameter d4 is too large, a radian of the fan-shaped grooves 23 will be too flat and the effects will be reduced; and if the diameter d4 is too small, the processing difficulty of the fan-shaped grooves 23 will be increased. Therefore, optionally, the diameter d4 of the fan-shaped grooves 23 is set to be 30-50 μm, for example, 30 μm, 36 μm, 42 μm and 50 μm. If the fan-shaped included angle α is too large or too small, the processing difficulty of the fan-shaped grooves 23 will be increased. Therefore, optionally, the fan-shaped included angle of the fan-shaped grooves 23 is set to be 40°-60°. If the distance d5 is too large, the effects of the fan-shaped grooves 23 in the aspects of reducing the friction, guiding the cutting chips and the like will be reduced; and if the distance d5 is too small, the processing difficulty of the fan-shaped grooves 23 will be increased. Therefore, optionally, the distance d5 between adjacent fan-shaped grooves 23 is set to be 40-100 μm, for example, 40 μm, 60 μm, 80 μm and 100 μm.

Referring to FIGS. 4 and 8, the value of a depth D of the fan-shaped grooves 23 may be based on the factors of many aspects. If the value of the depth D is too large, the strength of the cutting tool body will be affected; and if the depth D is too small, the effects of the fan-shaped grooves 23 in the aspects of reducing the friction, guiding the cutting chips and the like will be reduced, and the processing difficulty will also be greater. Therefore, optionally, the depth D of the fan-shaped grooves 23 is set to be 10-150 μm, for example, 10 μm, 65 μm, 110 μm and 150 μm.

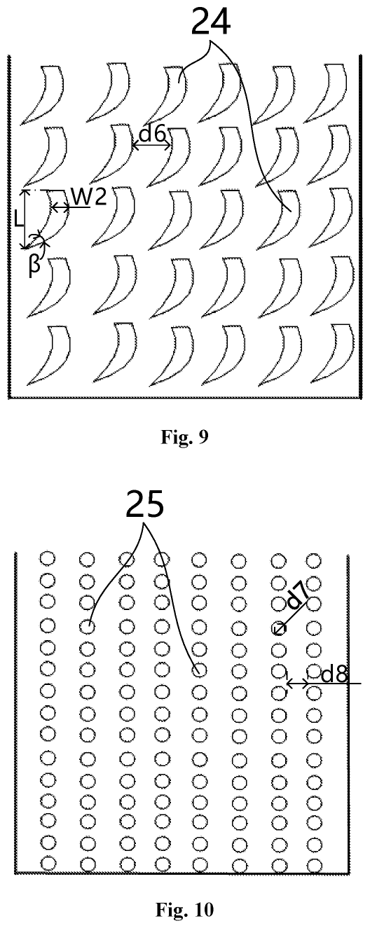

Referring to FIG. 9, a maximum width w2 and a maximum length L of the crescent-shaped concave portions 24 are determined according to an arrangement direction of the plurality of crescent-shaped concave portions 24, and bottom sharp corners of the crescent-shaped concave portions 24 point to the cutting edge. If the maximum width w2 or maximum length L of the crescent-shaped concave portions 24 is too large, the strength of the cutting tool body will be affected; if the maximum width w2 or maximum length L is too small, the processing difficulty of the crescent-shaped concave portions 24 will be increased. Therefore, optionally, the maximum width of the crescent-shaped concave portions 24 is set to be 30-50 μm, for example, 30 μm, 40 μm and 50 μm, and the maximum length is set to be 50-60 μm, for example, 50 μm, 55 μm and 60 μm.

If the angle β of the bottom sharp corners of the crescent-shaped concave portions is too large, the capacity of destroying the continuity of the water film will be reduced; and if the angle β is too small, the processing difficulty of the crescent-shaped concave portions 24 will be increased. Therefore, optionally, the angle of the bottom sharp corners of the crescent-shaped concave portions 24 is set to be 20°-30°, for example, 20°, 25° and 30°.

Referring to FIG. 4 and FIG. 9, if the value of a depth D of the crescent-shaped concave portions 24 is too large, the strength of the cutting tool body will be affected; and if the depth D is too small, the effects of the crescent-shaped concave portions 24 in the aspects of reducing the friction, guiding the cutting chips and the like will be reduced, and the processing difficulty will also be greater. Therefore, optionally, the depth D of the crescent-shaped concave portions 24 is set to be 10-150 μm, for example, 10 μm, 65 μm, 110 μm and 150 μm.

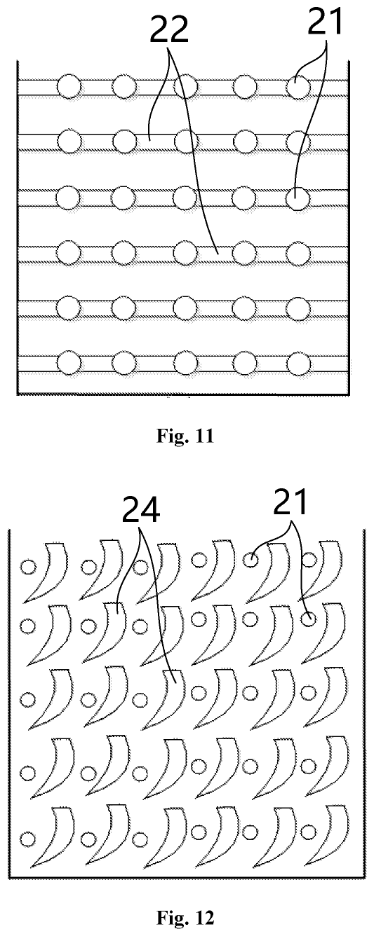

Referring to FIG. 4 and FIG. 10, in some embodiments, the tool surface includes the front tool surface 12 and the rear tool surface 13, the plurality of concave and/or convex parts 20 include a plurality of circular convex portions 25, and the plurality of circular convex portions 25 are formed on the front tool surface 12 and the rear tool surface 13. The circular convex portions 25 can cut off larger cutting chips, and form a channel conducive to discharging the cutting chips to reduce a contact area between the front tool surface 12 and the rear tool surface 13, which is suitable for both wet cutting and dry cutting. Optionally, the plurality of circular convex portions 25 may be formed in the regions on the front tool surface 12 and the rear tool surface 13 close to the cutting edge, so as to improve the film layer adhesive force in the regions close to the cutting edge and reduce the processing cost and time of the concave and/or convex parts.

Referring to FIG. 10, a diameter d7 of the circular convex portions 25 and a distance d8 between adjacent circular convex portions 25 may be based on the factors of many aspects. If the diameter d7 is too large, a roughness of the tool surface will be higher; and if the diameter d7 is too small, the processing difficulty of the circular convex portions 25 will be increased. Therefore, optionally, the diameter d7 of the circular convex portions 25 is set to be 30-50 μm, for example, 30 μm, 38 μm, 44 μm and 50 μm. If the distance d8 is too large, the effects of the circular convex portions 25 in the aspects of breaking the cutting chips, reducing the contact area and the like will be reduced; and if the distance d8 is too small, the processing difficulty of the circular convex portions 25 will be increased. Therefore, optionally, the distance d8 between adjacent circular convex portions 25 is set to be 40-100 μm, for example, 40 μm, 60 μm, 80 μm and 100 μm.

Referring to FIG. 4 and FIG. 10, the value of a height h of the circular convex portions 25 may be based on the factors of many aspects. If the height h is too large, the roughness of the tool surface will be higher; and if the height h is too small, the effects of the circular convex portions 25 in the aspects of breaking the cutting chips, reducing the contact area and the like will be reduced, and the processing difficulty will also be greater. Therefore, optionally, the height h of the circular convex portions 25 is set to be 10-150 μm, for example, 10 μm, 65 μm, 110 μm and 150 μm.

In order to improve the performances of the cutting tool, the above different forms of concave and/or convex parts may be combined, and the characteristics of different concave and/or convex parts are used to meet the performances of the cutting tool of more aspects. The convex portions and the concave portions are combined together, the convex portions can realize cutting chips breaking, the concave portions form an air cushion, which increases the turbulence degree of the airflow, changes the trajectory of particle movement, and buffers and reduces collision, and the combination of the two improves the wear resistance. Different concave portions and different grooves may also be combined together to realize circulation of the cutting fluid among the plurality of concave portions through the grooves, and generate a dynamic pressure effect of fluid to further reduce wear of the cutting tool.

Referring to FIG. 11, in some embodiments, the tool surface includes the front tool surface 12 and the rear tool surface 13, the plurality of concave and/or convex parts 20 include the plurality of circular concave portions 21 and the plurality of transverse grooves 22, and the plurality of circular concave portions 21 and the plurality of transverse grooves 22 are formed on the front tool surface 12 and the rear tool surface 13. Optionally, the plurality of circular concave portions 21 and the plurality of transverse grooves 22 may be formed in the regions of the front tool surface 12 and the rear tool surface 13 close to the cutting edge, so as to improve the film layer adhesive force in the regions close to the cutting edge and reduce the processing cost and time of the concave and/or convex parts.

In FIG. 11, respective transverse grooves 22 extend along a first direction, the plurality of transverse grooves 22 are arranged at intervals along a second direction perpendicular to the first direction, the plurality of circular concave portions 21 include a plurality of rows of circular concave portions 21 arranged at intervals along the second direction, and each row of circular concave portions are at least partially located in the corresponding transverse grooves 22.

Referring to FIG. 12, in some embodiments, the tool surface includes the front tool surface 12 and the rear tool surface 13, the plurality of concave and/or convex parts 20 include the plurality of circular concave portions 21 and the plurality of crescent-shaped concave portions 24, and the plurality of circular concave portions 21 and the plurality of crescent-shaped concave portions 24 are formed on the front tool surface 12 and the rear tool surface 13. The plurality of circular concave portions 21 and the plurality of crescent-shaped concave portions 24 may be formed in the regions of the front tool surface 12 and the rear tool surface 13 close to the cutting edge, so as to improve the film layer adhesive force in the regions close to the cutting edge and reduce the processing cost and time of the concave and/or convex parts.

In FIG. 12, the plurality of circular concave portions 21 and the plurality of crescent-shaped concave portions 24 are arranged in an array, and the plurality of circular concave portions 21 and the plurality of crescent-shaped concave portions 24 are alternately disposed along at least one arrangement direction of the array.

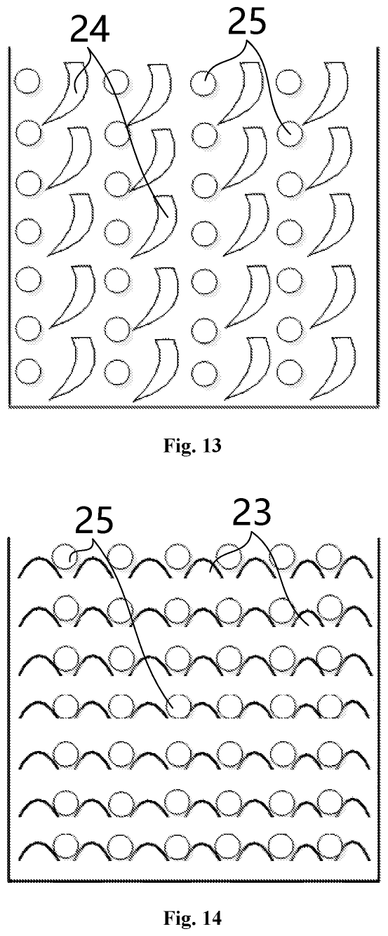

Referring to FIGS. 13 and 14, in some embodiments, the plurality of concave and/or convex parts 20 include the plurality of circular convex portions 25 and also include the plurality of circular concave portions 21, the plurality of fan-shaped grooves 23 or the plurality of crescent-shaped concave portions 24, and the plurality of circular concave portions 21, the plurality of fan-shaped grooves 23 or the plurality of crescent-shaped concave portions 24 are formed on the front tool surface 12 and the rear tool surface 13. The plurality of circular concave portions 21, the plurality of fan-shaped grooves 23 or the plurality of crescent-shaped concave portions 24 may be formed in the regions of the front tool surface 12 and the rear tool surface 13 close to the cutting edge, so as to improve the film layer adhesive force in the regions close to the cutting edge and reduce the processing cost and time of the concave and/or convex parts.

In FIG. 13 and FIG. 14, the plurality of circular convex portions 25 are arranged in an array, and the plurality of circular concave portions 21, the plurality of fan-shaped grooves 23 or the plurality of crescent-shaped concave portions 24 are arranged in an array and alternately disposed with the plurality of circular convex portions 25 along at least one direction of the array.

In the above embodiments, these concave and/or convex parts such as the concave portions, grooves or convex portions are actually subtle on the tool surface, have little influence on the smoothness of the surface of the cut workpiece and do not easily affect the strength and other performances of the cutting tool. Moreover, the plurality of concave and/or convex parts are arranged and distributed according to certain rules, and can form a relatively wear-resistant structure similar to a conch surface, a yak horn, a mole cricket body surface or fish scales, etc., so as to improve the performances of the cutting tool.

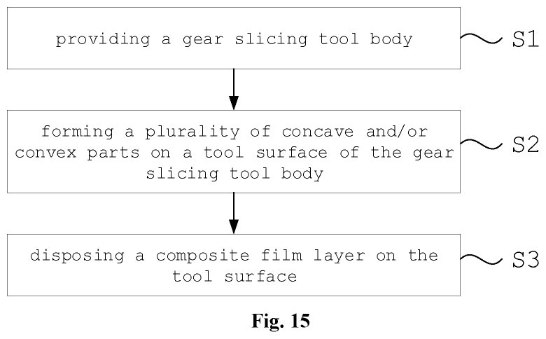

FIG. 15 is a flowchart of some embodiments of a manufacture method of the gear slicing tool according to the present disclosure. Based on the gear slicing tool according to the aforementioned respective embodiments and FIG. 15, the embodiment of the present disclosure provides a manufacture method of the aforementioned gear slicing tool, which includes steps S1 to S3. In step S1, the gear slicing tool body 10 is provided. In step S2, the plurality of concave and/or convex parts 20 are formed on the tool surface of the gear slicing tool body 10, wherein the concave and/or convex parts 20 are arranged at intervals along at least one direction on the tool surface.

In step S3, the composite film layer 30 is disposed on the tool surface. The step of disposing the composite film layer 30 here includes: forming the metal film layer 31 on the tool surface and covering the surface of the concave and/or convex parts 20 with the metal film layer 31, wherein the material of the metal film layer 31 includes metal, such as chromium or titanium; forming the first film layer 321 on the metal film layer 31, wherein the material of the first film layer 321 includes the nitride of the metal; forming the second film layer 322 on the first film layer 321, wherein the material of the second film layer 322 includes the nitride of the alloy of the metal and aluminum; and forming the functional film layer 33 on the second film layer 322, wherein the material of the functional film layer 33 includes the nitride of the alloy of the metal, aluminum and silicon.

In some embodiments, the metal film layer 31 is formed by a pulsed arc method, and the first film layer 321, the second film layer 322 and the functional film layer 33 are all deposited by a magnetron sputtering method.

In some embodiments, the method further includes: performing ultrasonic cleaning and nitrogen gas blow-drying on the gear slicing tool body 10 before forming the plurality of concave and/or convex parts 20.

In some embodiments, the method further includes: performing vacuum heating and argon gas cleaning on the gear slicing tool body 10 before disposing the composite film layer 30.

In the following, the embodiments of the structure of the aforementioned gear slicing tool and the manufacture method are combined for illustration by examples. The preparation process of the gear slicing tool is as follows:
1) processing of the concave and/or convex parts: the gear slicing tool body is subjected to ultrasonic grease cleaning with degreasing powder for 20 minutes, and then the gear slicing tool body is placed in deionized water and alcohol respectively for ultrasonic cleaning for 30 minutes, is blow-dried with nitrogen gas, and is put into a blast drying oven for standby. In a micro-texture region to be processed, the means such as laser or 3D printing is used for processing to form the concave and/or convex parts, and the gear slicing tool body is cleaned and dried again for standby.
2) preparation of the composite film layer:
a) cleaning: the gear slicing tool body processed in step 1) is put into a vacuum chamber, the rotating speed of a turret is adjusted to be 2-3 r/min, vacuum suction is performed to 1.5×10⁻³ Pa, the vacuum chamber is heated to 350-400° C., then heat preservation is performed for 15 minutes, Ar is introduced, a pulse bias voltage is 800-1000V, and the gear slicing tool body is cleaned by the Ar gas for 15-20 minutes.
B) film plating: firstly, a Cr film layer is plated by using the pulse arc method, wherein a pulse frequency is 15-20 Hz, an arc current is 75-90 A, and pulse times are 8000-12000; for the transition film layer, the CrN film layer and the AlCrN film layer are deposited by the magnetron sputtering method, N₂ is firstly introduced, a working gas pressure is 0-0.3 Pa, the bias voltage is 100-150 V, a Cr target voltage is −800 V, the CrN film layer is deposited for 5-10 minutes, and N2 is turned off. Then Ar is introduced, then N₂ is introduced when the working gas pressure reaches 0.3 Pa, the working gas pressure is gradually increased from 0.3 Pa to 0.5 Pa, the bias voltage is 100-150 V, the AlCr alloy target voltage is −800 V, and the AlCrN film layer is deposited for 90-120 minutes. Finally, the functional film layer is deposited by the magnetron sputtering method, a Si target is turned on, the working gas pressure is 0.05-0.1 Pa, the bias voltage is 50-150 V, and the AlCrSiN film layer is deposited for 100-120 minutes.
C) cooling: after the vacuum chamber is cooled to room temperature, the gear slicing tool body obtained in 2) is taken out.

So far, respective embodiments of the present disclosure have been described in detail. In order to avoid obscuring concepts of the present disclosure, some details commonly known in the art are not described. Those skilled in the art can fully understand how to implement the technical solutions disclosed here according to the above descriptions.

Although some specific embodiments of the present disclosure have been described in detail by examples, it should be understood by those skilled in the art that the above examples are only for illustration, not for limiting the scope of the present disclosure. Those skilled in the art should understand that the above embodiments can be modified or some technical features can be equivalently substituted without departing from the scope and spirits of the present disclosure. The scope of the present disclosure is defined by the appended claims.

What is claimed is:

1. A gear slicing tool, comprising:
a gear slicing tool body, wherein a plurality of at least one of concave parts and convex parts are formed on a tool surface of the gear slicing tool body, and the plurality of the parts are arranged at intervals along at least one direction on the tool surface; and
a composite film layer disposed on the tool surface, wherein the composite film layer comprises:
a metal film layer formed on the tool surface and covering a surface of the plurality of the parts, wherein a material of the metal film layer comprises metal;
a transition film layer disposed on one side of the metal film layer away from the tool surface, wherein the transition film layer comprises a first film layer formed on the metal film layer and a second film layer formed on the first film layer, a material of the first film layer comprises a nitride of the metal, and a material of the second film layer comprises a nitride of an alloy of the metal and aluminum; and
a functional film layer disposed on one side of the transition film layer away from the tool surface, and a material of the functional film layer comprises a nitride of an alloy of the metal, aluminum and silicon.

2. The gear slicing tool according to claim 1, wherein the metal is chromium or titanium.

3. The gear slicing tool according to claim 1, wherein at least one of a thickness of the metal film layer is 0.2-0.3 μm, a thickness of the transition film layer is 0.5-0.8 μm, and a thickness of the functional film layer (33) is 1-3 μm.

4. The gear slicing tool according to claim 1, wherein the tool surface comprises a front tool surface, the plurality of the parts comprise a plurality of circular concave portions, a plurality of transverse grooves, a plurality of fan-shaped grooves or a plurality of crescent-shaped concave portions, and the plurality of circular concave portions, the plurality of transverse grooves, the plurality of fan-shaped grooves or the plurality of crescent-shaped concave portions are formed on the front tool surface.

5. The gear slicing tool according to claim 1, wherein the tool surface comprises a front tool surface and a rear tool surface, the plurality of the parts comprise a plurality of circular concave portions and a plurality of transverse grooves, and the plurality of circular concave portions and the plurality of transverse grooves are formed on the front tool surface and the rear tool surface.

6. The gear slicing tool according to claim 5, wherein respective transverse grooves extend along a first direction, the plurality of transverse grooves are arranged at intervals along a second direction perpendicular to the first direction, the plurality of circular concave portions comprise a plurality of rows of circular concave portions arranged at intervals along the second direction, and each row of circular concave portions are at least partially located in the corresponding transverse grooves.

7. The gear slicing tool according to claim 1, wherein the tool surface comprises a front tool surface and a rear tool surface, the plurality of the parts comprise a plurality of circular concave portions and a plurality of crescent-shaped concave portions, and the plurality of circular concave portions and the plurality of crescent-shaped concave portions are formed on the front tool surface and the rear tool surface.

8. The gear slicing tool according to claim 7, wherein the plurality of circular concave portions and the plurality of crescent-shaped concave portions are arranged in an array, and the plurality of circular concave portions and the plurality of crescent-shaped concave portions are alternately disposed along at least one arrangement direction of the array.

9. The gear slicing tool according to claim 1, wherein the tool surface comprises a front tool surface and a rear tool surface, the plurality of the parts comprise a plurality of circular convex portions, and the plurality of circular convex portions are formed on the front tool surface and the rear tool surface.

10. The gear slicing tool according to claim 9, wherein the plurality of the parts further comprise a plurality of circular concave portions, a plurality of fan-shaped grooves or a plurality of crescent-shaped concave portions, and the plurality of circular concave portions, the plurality of fan-shaped grooves or the plurality of crescent-shaped concave portions are formed on the front tool surface and the rear tool surface.

11. The gear slicing tool according to claim 10, wherein the plurality of circular convex portions are arranged in an array, and the plurality of circular concave portions, the plurality of fan-shaped grooves or the plurality of crescent-shaped concave portions are arranged in an array and are alternately disposed with the plurality of circular convex portions along at least one direction of the array.

12. The gear slicing tool according to claim 4, wherein the circular concave portion has a diameter of 30-50 μm and a depth of 10-150 μm, and a distance between adjacent circular concave portions is 40-100 μm.

13. The gear slicing tool according to claim 9, wherein the circular convex portion has a diameter of 30-50 μm and a height of 10-150 μm, and a distance between adjacent circular convex portions is 40-100 μm.

14. The gear slicing tool according to claim 4, wherein the transverse groove has a width of 40-100 μm and a depth of 10-150 μm, and a distance between adjacent transverse grooves is 40-100 μm.

15. The gear slicing tool according to claim 4, wherein the fan-shaped groove has a diameter of 30-50 μm, a fan-shaped included angle of 40°-60°, and a depth of 10-150 μm, and a distance between adjacent fan-shaped grooves is 40-100 μm.

16. The gear slicing tool according to claim 4, wherein the crescent-shaped concave portion has a maximum width of 30-50 μm, a maximum length of 50-60 μm and a depth of 10-150 μm, an angle of a bottom sharp corner of the crescent-shaped concave portion is 20°-30°, and a distance between adjacent crescent-shaped concave portions is 40-100 μm.

17. A method of manufacturing a gear slicing tool, the method comprising:
providing a gear slicing tool body;
forming a plurality of at least one of concave parts and convex parts on a tool surface of the gear slicing tool body, wherein the plurality of the parts are arranged at intervals along at least one direction on the tool surface; and
disposing a composite film layer on the tool surface, wherein the step of disposing the composite film layer comprises:
forming a metal film layer on the tool surface, and covering a surface of the plurality of the parts with the metal film layer, wherein a material of the metal film layer comprises metal;
forming a first film layer on the metal film layer, wherein a material of the first film layer comprises a nitride of the metal;
forming a second film layer on the first film layer, wherein a material of the second film layer comprises a nitride of an alloy of the metal and aluminum; and
forming a functional film layer on the second film layer, wherein a material of the functional film layer comprises a nitride of an alloy of the metal, aluminum and silicon.

18. The method according to claim 17, wherein the metal film layer is formed by a pulsed arc method; and
wherein the first film layer, the second film layer, and the functional film layer are deposited by a magnetron sputtering method.

19. The method according to claim 17, further comprising:
performing ultrasonic cleaning and nitrogen gas blow-drying on the gear slicing tool body before forming the plurality of the parts.

20. The method according to claim 17, further comprising:
performing vacuum heating and argon gas cleaning on the gear slicing tool body before disposing the composite film layer.
